(19) United States
(12) Patent Application Publication
(10) Pub. No.: US 2023/0417101 A1
(43) Pub. Date: Dec. 28, 2023

(54) TRANSITION GLASS

(71) Applicant: Greg Eguaoje, Wylie, TX (US)

(72) Inventor: Greg Eguaoje, Wylie, TX (US)

(21) Appl. No.: 18/215,746

(22) Filed: Jun. 28, 2023

Related U.S. Application Data
(60) Provisional application No. 63/356,092, filed on Jun. 28, 2022.

(51) Int. Cl. E06B 9/24; B60J 3/06; C03C 23/00

(52) U.S. Cl. CPC E06B 9/24; B60J 3/06; C03C 23/00; E06B 2009/2417

(57) ABSTRACT

Glass which has been chemically treated to make it transition from clear to tinted or opaque as temperature increases, and transition back to clear when temperature falls. The glass is manufactured for use in commercial and non-commercial buildings, and for use in vehicles, planes, boats, or other machinery The glass can be chemically treated on an entire pane or treated on only a portion of a single pane.

### CROSS REFERENCE TO RELATED APPLICATIONS

This application claims priority to, and the benefit of the filing date of, provisional application no. 63/356,092 filed on Jun. 28, 2022.

### SUMMARY

Glass, suitable for the windows of buildings and vehicles, which has been chemically treated so it transitions from fully clear to opaque as temperature increases, and transitions back to clear when temperature falls. The glass is manufactured for use in commercial and non-commercial buildings, and for use in vehicles, planes, boats, or other machinery. The glass may be only treated on part of a pane, such that only part of a window darkens with increased temperature.

### BRIEF DESCRIPTION OF DRAWINGS

FIGS. 1-4 depict a vehicle with glass according to some embodiments presently disclosed.

FIGS. 5-6 depict a building with glass according to some embodiments presently disclosed.

### DETAILED DESCRIPTION

In the following description, like reference numbers are used to identify like elements. Furthermore, the drawings are intended to illustrate major features of exemplary embodiments in a diagrammatic manner. The drawings are not intended to depict every feature of every implementation nor relative dimensions of the depicted elements and are not drawn to scale.

In the following description, numerous specific details are set forth to clearly describe various specific embodiments disclosed herein. One skilled in the art, however, will understand that the presently claimed invention may be practiced without all of the specific details discussed below. In other instances, well known features have not been described so as not to obscure the invention.

As described herein, the term “pivotally connected” shall be used to describe a situation wherein two or more identified objects are joined together in a manner that allows one or both of the objects to pivot, and/or rotate about or in relation to the other object in either a horizontal or vertical manner.

As described herein, the term “removably coupled” and derivatives thereof shall be used to describe a situation wherein two or more objects are joined together in a non-permanent manner so as to allow the same objects to be repeatedly joined and separated.

Also, it is to be understood that the phraseology and terminology used herein is for the purpose of description and should not be regarded as limiting. The use of “including,” “comprising,” or “having” and variations thereof herein is meant to encompass the items listed thereafter as well as additional items. Unless limited otherwise, the terms “connected,” “coupled,” and “mounted,” and variations thereof herein are used broadly and encompass direct and indirect connections, couplings, and mountings. In addition, the terms “connected” and “coupled” and variations thereof are not restricted to physical or mechanical connections or couplings.

In addition, it should be understood that embodiments of the invention include hardware components or modules that, for purposes of discussion, may be illustrated and described as if the majority of the components were implemented solely in hardware. It should be noted that a plurality of hardware devices, as well as a plurality of different structural components may be utilized to implement the invention. Furthermore, and as described in subsequent paragraphs, the specific mechanical configurations illustrated in the drawings are intended to exemplify embodiments of the invention and that other alternative mechanical configurations are possible.

It is well known that UV rays from the sun are very harmful to humans and cause skin cancer by causing damage to humans' DNA. The harmful impact of Ultraviolet (UV) rays is further increase by the rise in global warming. Glass that is currently being utilized for buildings' windows and vehicles' windows provides little or no protection from harmful UV rays from the sun and do not offer any relief in the rising cost of keeping the space inside the buildings and vehicles cool and comfortable for humans.

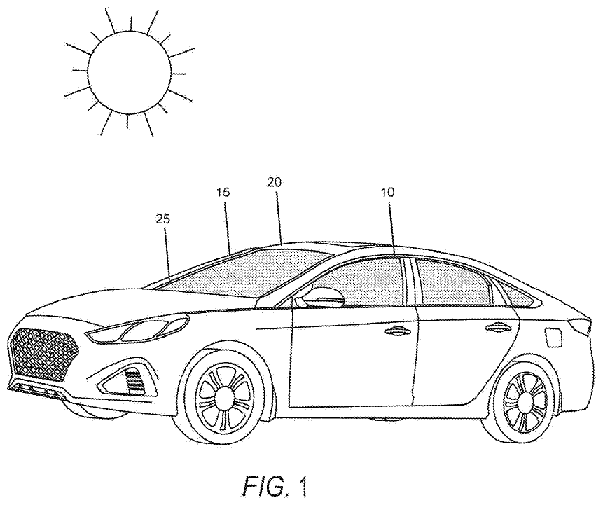

FIG. 1 shows a perspective view of a vehicle (5) with the side windows (10) entirely made of the transition glass of the instant invention, and a front windshield (15) which has an upper portion (20) which is transition glass and a lower portion (25) which is not transition glass.

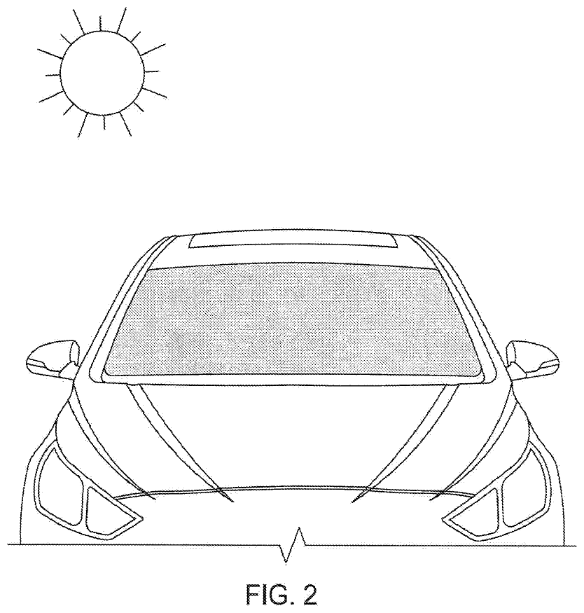

FIG. 2 shows the vehicle of FIG. 1 in a front view.

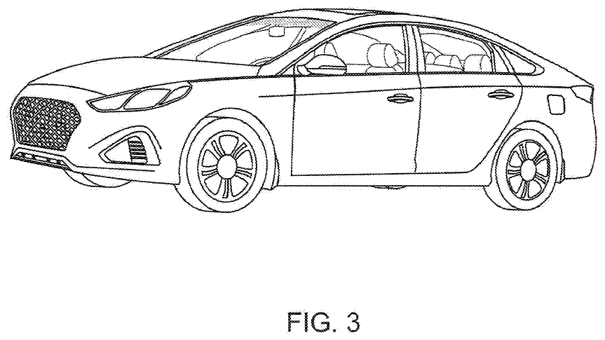

FIG. 3 shows the vehicle of FIG. 1 in a perspective view when the temperature is below the transition temperature to darken the glass.

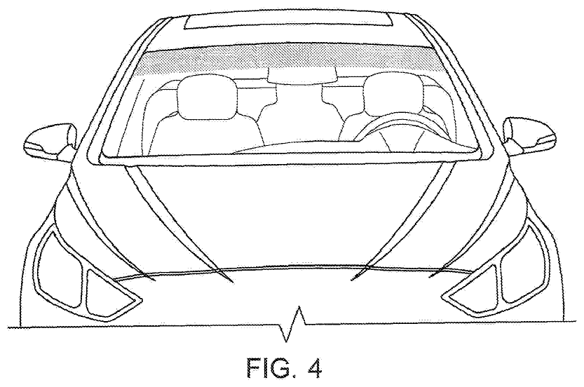

FIG. 4 shows the vehicle of FIG. 1 in a front view when the temperature is below the transition temperature to darken the glass.

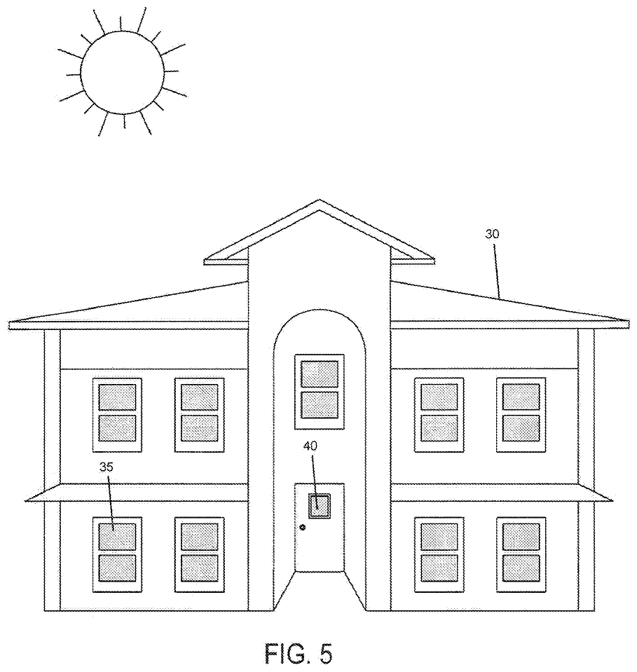

FIG. 5 shows a building (30) with transition glass windows (35) and transition glass door pane (40).

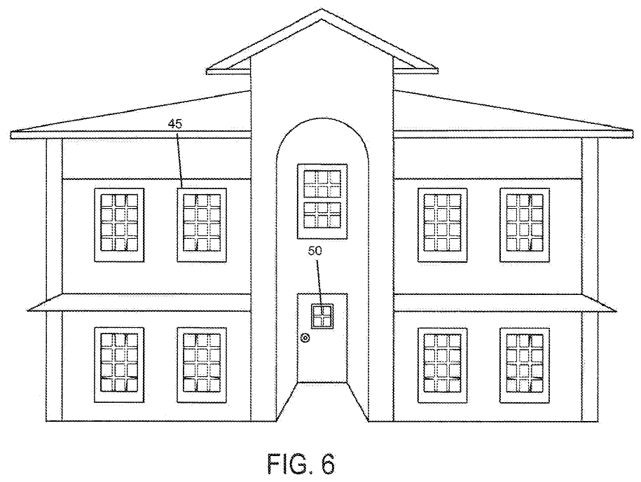

FIG. 6 shows the building of FIG. 5 with transition glass windows (45) and transition glass door pane (50) when the temperature is below the transition temperature to darken the glass.

The presently disclosed glass provides protection against the harmful UV rays, provides energy savings, and is environmentally friendly. According to some embodiments, the presently disclosed glass is able to transition from being clear/transparent in low temperatures to dark as temperature rises. According to some embodiments, the presently disclosed glass is able to transition from being clear/transparent to dark as temperature increases and transition from dark to clear/transparent when temperature decreases. According to some embodiments, the presently disclosed glass is sensitive to changes in temperature. According to some embodiments, the presently disclosed glass is able to transition from clear to dark and back to clear based on temperature.

Presently disclosed glass can be installed in windows of buildings and/or vehicles. Vehicles may include, for example, planes, trains, cars, buses, or boats. Buildings may include, for example, commercial and/or residential buildings.

According to some embodiments, presently disclosed glass changes from clear/transparent to being dark colored as temperature rises (from pre-determined level). According to some embodiments, presently disclosed glass returns to its original clear/transparent state as temperature drops.

The disclosed glass would lower energy consumption need to cool buildings, leave less carbon footprint, lower demand on electric power grid, lower cost of electricity, reduce temperature inside buildings by, for example, 20 degrees, provide solar UV protection during high temperatures, lower cost of operating vehicles by reducing the power requirement for cooling the interior of the vehicle.

According to some embodiments, only a portion of presently disclosed glass is configured to transition from being clear/transparent to dark and back as temperature changes. For example, for safety reasons, it may not be safe for a vehicle's windshield to turn dark in its entirety as it may prevent operator of the vehicle from seeing where they are going. Therefore, according to some embodiments presently disclosed, only a portion of the presently disclosed glass turns dark as temperature increases from a pre-determined level.

According to some embodiments, an upper sun visor portion of the vehicle's glass is configured to transition from being clear/transparent to dark and back as temperature changes. The polarized upper sun visor section of the glass windshield (FIGS. 3&4) can improve visibility by reducing glare from the sun when in an automobile. The chemical molecules that are used to make this polarized portion of the glass would filter and or block some light waves from passing through before it reaches the eyes. This would make driving easier in sunny conditions or nighttime due to oncoming headlight glare traffic, thereby providing comfort and safety for motorists on both sides of the road.

While several illustrative embodiments of the invention have been shown and described, numerous variations and alternative embodiments will occur to those skilled in the art. Such variations and alternative embodiments are contemplated and can be made without departing from the scope of the invention as defined in the appended claims.

As used in this specification and the appended claims, the singular forms “a,” “an,” and “the” include plural referents unless the content clearly dictates otherwise. The term “plurality” includes two or more referents unless the content clearly dictates otherwise. Unless defined otherwise, all technical and scientific terms used herein have the same meaning as commonly understood by one of ordinary skill in the art to which the disclosure pertains.

The foregoing detailed description of exemplary and preferred embodiments is presented for purposes of illustration and disclosure in accordance with the requirements of the law. It is not intended to be exhaustive nor to limit the invention to the precise form(s) described, but only to enable others skilled in the art to understand how the invention may be suited for a particular use or implementation. The possibility of modifications and variations will be apparent to practitioners skilled in the art. No limitation is intended by the description of exemplary embodiments which may have included tolerances, feature dimensions, specific operating conditions, engineering specifications, or the like, and which may vary between implementations or with changes to the state of the art, and no limitation should be implied therefrom. Applicant has made this disclosure with respect to the current state of the art, but also contemplates advancements and that adaptations in the future may take into consideration of those advancements, namely in accordance with the then current state of the art. It is intended that the scope of the invention be defined by the Claims as written and equivalents as applicable.

Reference to a claim element in the singular is not intended to mean “one and only one” unless explicitly so stated. Moreover, no element, component, nor method or process step in this disclosure is intended to be dedicated to the public regardless of whether the element, component, or step is explicitly recited in the claims. No claim element herein is to be construed under the provisions of 35 U.S.C. Sec. 112, sixth paragraph, unless the element is expressly recited using the phrase “means for . . . ” and no method or process step herein is to be construed under those provisions unless the step, or steps, are expressly recited using the phrase “step(s) for . . . .”

1. A pane of glass which has been chemically treated to transition from clear to semitransparent or opaque in response to an increase in the temperature of the glass, and to transition back to clear in response to a decrease in the temperature of the glass.

2. The pane of glass of claim 1, wherein the chemical treatment of the glass is only applied to part of the pane of glass such that only part of the pane of glass transitions from clear to semitransparent or opaque in response to changes in temperature.

3. The pane of glass of claim 1, wherein the pane of glass is dimensioned appropriately for use in a building window, a building door, a vehicle windshield, or a vehicle window.

4. The pane of glass of claim 1, wherein the chemical treatment of the polarized upper visor section of automobile windshield improves visibility in adverse conditions during day and night, improving driving conditions for safety considerations.
